(19) United States
(12) Patent Application Publication
(10) Pub. No.: US 2011/0024517 A1
(43) Pub. Date: Feb. 3, 2011

(54) Swirl spraying nozzle for sprayng liquid fuel, and method of producing same, and a nozzle assembly for a burner with the swirl spraying nozzle

(76) Inventors: Andreas Heilos, Mulheim an der Ruhr (DE); Oliver Schneider, Wesel (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/935,027

(22) PCT Filed: Mar. 23, 2009
(86) PCT No.: PCT/EP09/53361

§ 371 Date: Sep. 28, 2010

(30) Foreign Application Priority Data
Apr. 1, 2008 (EP) 08006681.4

(51) Int. Cl. B05B 1/34

(52) U.S. Cl. 239/11; 239/463

(57) ABSTRACT

A swirl spraying nozzle for spraying liquid fuel is provided. The swirl spraying nozzle includes a nozzle body including a hollow cylinder with a base terminating the hollow cylinder on one side and with a head terminating the hollow cylinder on the other side such that a swirl chamber is formed in the nozzle body. An admission hole is provided in the hollow cylinder in the vicinity of the base and is arranged in a plane perpendicular to the longitudinal axis of the hollow cylinder. The admission hole is positioned at an angle in the circumferential direction of the hollow cylinder. An outlet hole is provided in the head on the longitudinal axis of the hollow cylinder such that a liquid can flow tangentially through the admission hole with a swirling action into the swirl chamber and can flow out axially from the swirl chamber through the outlet opening.

### CROSS REFERENCE TO RELATED APPLICATIONS

This application is the US National Stage of International Application No. PCT/EP2009/053361 filed Mar. 23, 2009, and claims the benefit thereof. The International Application claims the benefits of European Application No. 08006681.4 EP filed Apr. 1, 2008. All of the applications are incorporated by reference herein in their entirety.

### FIELD OF INVENTION

The invention relates to a swirl atomizing nozzle for atomizing liquid fuel, a method for producing the swirl atomizing nozzle, and a nozzle assembly for a combustion chamber, in particular for a gas turbine, having the swirl atomizing nozzle.

### BACKGROUND OF INVENTION

A gas turbine comprises a compressor, a combustion chamber and a turbine. A combustion air/fuel mixture is made to ignite in the combustion chamber, resulting in a stream of heating gas. The stream of heating gas is expanded in the turbine which drives the compressor and makes useful power available. The useful power can be, for example, a shaft power for driving a generator in a power station.

Both gaseous and liquid fuels can be burned in the combustion chamber in the gas turbine. If a liquid fuel is used it must, prior to burning, be atomized to a predetermined droplet size distribution and concentration in the combustion air. Liquid fuel is conventionally atomized by means of an atomizing nozzle.

The atomizing nozzle is housed directly in the combustion chamber or in a premixing chamber. The atomizing nozzle needs to have a predetermined and limited structural depth due to the structural confinements of the combustion chamber or, as the case may be, premixing chamber. An atomizing nozzle constructed to take account of the limited structural depth will have a limited atomizing effect, with the result that the atomizing nozzle is fitted with an additional swirl-producing device for producing a swirl in the liquid fuel/combustion air mixture. A conventional atomizing nozzle having swirl production is turned, milled and/or drilled from a complete material or alternatively produced having a micro-laminate design, which is expensive.

### SUMMARY OF INVENTION

An object of the invention is to provide a swirl atomizing nozzle for atomizing liquid fuel, a method for producing the swirl atomizing nozzle, and a nozzle assembly for a gas turbine burner having the swirl atomizing nozzle, wherein the swirl atomizing nozzle and nozzle assembly are able to be produced inexpensively and are effective in terms of atomizing the liquid fuel.

The inventive swirl atomizing nozzle for atomizing liquid fuel has a nozzle body with a hollow cylinder terminated on one side by a base and on the other by a head so that a swirl chamber is formed in the nozzle body, wherein at least one admission hole that is arranged in a plane perpendicular to the longitudinal axis of the hollow cylinder and positioned at an angle in the circumferential direction of the hollow cylinder is provided in the vicinity of the base in the hollow cylinder, and wherein in the head an outlet hole is provided that lies on the longitudinal axis of the hollow cylinder so that a liquid can flow tangentially into the swirl chamber through the admission hole under the impact of a swirling action and flow axially out of the swirl chamber through the outlet opening.

The inventive method for producing the swirl atomizing nozzle has the following steps: providing a blank that has a hollow cylinder terminated on one side by a base and having an open longitudinal end on the other, wherein at least one admission hole that is arranged in a plane perpendicular to the hollow cylinder's longitudinal axis and positioned at an angle tangentially to the circumference of the hollow cylinder is provided in the vicinity of the base in the hollow cylinder, and wherein a ring step around the longitudinal axis of the hollow cylinder is optionally embodied on the outer circumference of the hollow cylinder viewed in the longitudinal direction of the hollow cylinder between the admission hole and open longitudinal end so that referred to the ring step the outer diameter of the hollow cylinder is smaller on the side with the admission hole than on the side with the open longitudinal end; providing a press having a retaining sleeve and a shaping stamp that is formed by a cone and a floor and aligns with the retaining sleeve; inserting the blank into the retaining sleeve base first until the retaining sleeve makes contact, wherein the open longitudinal end of the blank faces the cone; pushing the retaining sleeve toward the shaping stamp so that the open longitudinal end will at the same time be reshaped inwardly by the cone and floor and the open longitudinal end forming an outlet opening will come to rest perpendicularly to the longitudinal axis of the blank.

The inventive nozzle assembly for a gas turbine burner has a conical section embodied in which is a nozzle assembly chamber, wherein a nozzle assembly chamber outlet hole inserted into which is a swirl atomizing nozzle with its base projecting into the nozzle assembly chamber is provided in the conical section so that a liquid fuel/air mixture can flow from the nozzle assembly chamber into the swirl chamber through the admission hole under the impact of a swirling action and out of the swirl chamber through the outlet opening from the nozzle assembly chamber.

The swirl atomizing nozzle can be produced inexpensively using the inventive method and will be highly effective in terms of its atomizing capability. The liquid fuel/air mixture furthermore flows from the nozzle assembly chamber into the gas turbine combustion chamber through the swirl atomizing nozzle, the swirl atomizing nozzle being housed in the conical section of the nozzle assembly. Atomizing of the liquid fuel in the combustion air effected with a swirling action thus takes place in the conical section of the nozzle assembly by means of the swirl atomizing nozzle, as a result of which a high degree of homogeneity can be achieved in the droplet size distribution of the liquid fuel in the combustion air. Atomizing of the liquid fuel in the combustion air by means of the nozzle assembly is therefore effective.

It is preferred for the diameter-to-height ratio of the nozzle body to be less than one. The height of the nozzle body will consequently be small so that the swirl atomizing nozzle will have a small structural height. That is advantageous because only a limited amount of structural space is available in the outlet hole in the nozzle assembly chamber so that the inventive swirl atomizing nozzle can be fitted inside the inventive nozzle assembly.

It is furthermore preferred for the swirl atomizing nozzle to have in one plane two admission holes, in particular drilled holes and/or slots, arranged point-symmetrically around the midpoint of the hollow cylinder and having longitudinal axes that run parallel to each other. It is also preferred for the plane to be sited closer to the base than to the head.

A swirl flow can hence effectively be produced in the swirl chamber owing to the thus inventively defined position of the admission holes in the swirl chamber so that the atomizing effect of the swirl atomizing nozzle will be substantial.

It is preferred for a ring step around the longitudinal axis of the hollow cylinder to be embodied on the outer circumference of the hollow cylinder viewed in the longitudinal direction of the hollow cylinder between the admission hole and head so that the outer diameter of the hollow cylinder will be smaller at the admission hole than at the head.

It will as a result be inventively possible for the blank to be supported on the retaining sleeve during the production of the swirl atomizing nozzle. The base and the region of the blank between the ring step and base will hence be held by the retaining sleeve during the production of the swirl atomizing nozzle so that said region will not be affected by the shaping process. Rather it will be the case that the region of the blank extending from the ring step to the open longitudinal end of the blank will be affected so that undesired bending of the blank in the region of the blank between the ring step and base cannot occur during the production of the swirl atomizing nozzle.

The blank is preferably a turned part. This will enable the blank to be produced economically in large quantifies.

It is furthermore preferred for the shaping stamp to be mounted freely rotating around the axis of symmetry of its cone so that the blank will be roll-formed. The blank can thereby advantageously be worked having a large wall thickness.

It is also preferred for the method for producing the swirl atomizing nozzle to have the following step: boring the outlet opening to a predetermined diameter. The diameter of the outlet opening can thereby advantageously be established after the roll-forming process. In a borderline case the open longitudinal end will be reshaped inwardly such that the outlet opening is totally sealed.

It is preferred for the method for producing the swirl-producing nozzle to have the following step: producing the admission hole as a tangentially positioned slot and/or drilled hole.

An admission hole can thereby be advantageously produced in the nozzle body of the swirl atomizing nozzle after it has undergone roll-forming.

It is also preferred as regards the nozzle assembly for a plurality of the nozzle assembly chamber outlet holes and the swirl atomizing nozzles respectively located therein to be arranged distributed around the circumference of the conical section. A homogeneous flow of the liquid fuel/air mixture around the nozzle assembly will be advantageously achieved thereby.

It is further preferred for the swirl atomizing nozzle to be caulked and/or soldered into position in the nozzle assembly chamber outlet hole.

The swirl atomizing nozzle will thereby be secured stably and inexpensively in the nozzle assembly chamber outlet hole.

### BRIEF DESCRIPTION OF THE DRAWINGS

The invention is explained below with the aid of a preferred exemplary embodiment of an inventive swirl atomizing nozzle and inventive nozzle assembly and with reference to the attached schematic drawings, in which:

FIG. 1 is a longitudinal cross-section through an inventive swirl atomizing nozzle,

FIG. 2 is a longitudinal cross-section through a blank of the swirl atomizing nozzle as shown in FIG. 1,

FIG. 3 is a cross-section through the blank as shown in FIG. 2,

FIG. 4 is a longitudinal cross-section through a press for producing the swirl atomizing nozzle as shown in FIG. 1 with a blank as shown in FIGS. 2 and 3, and

FIG. 5 is a longitudinal cross-section through an inventive nozzle assembly.

### DETAILED DESCRIPTION OF INVENTION

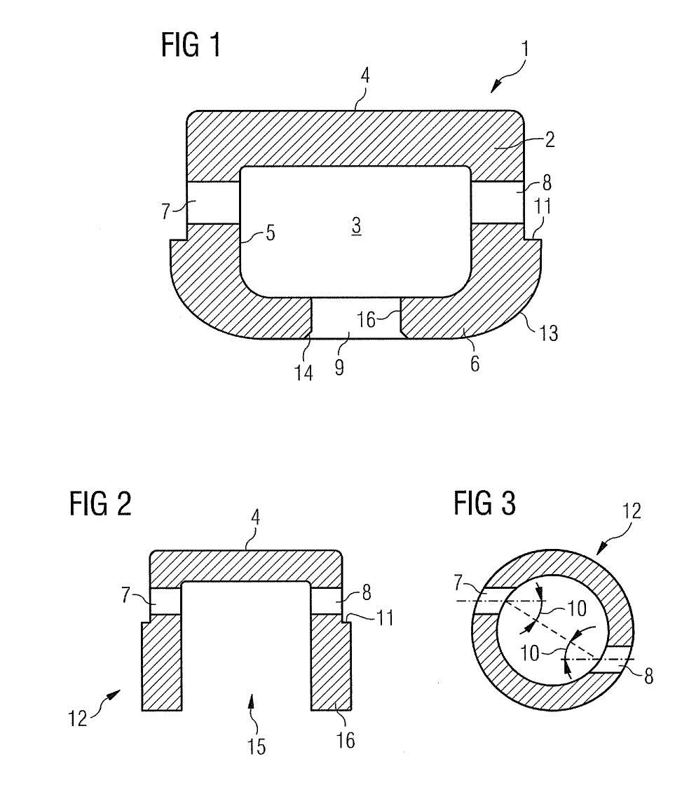

As can be seen in FIG. 1, a swirl atomizing nozzle 1 has a nozzle body 2 formed from a hollow cylinder 5 terminated by a base 4 at one end and a head 6 at the other. A swirl chamber 3 is thereby formed from the hollow cylinder 5, the base 4, and the head 6. Embodied in the hollow cylinder 5 in the region of the base 4 leading into the swirl chamber 3 is a first admission hole 7 and a second admission hole 8 (see FIG. 3). The admission holes 7, 8 lie in a plane that is perpendicular to the longitudinal axis of the hollow cylinder 5 and in which the admission holes 7, 8 are positioned circumferentially in the hollow cylinder 5 at a pitch 10 in the same direction. The admission holes 7, 8 are furthermore arranged point-symmetrically around the longitudinal axis of the hollow cylinder 5, with the longitudinal axes of the admission holes 7, 8 being mutually parallel. The admission holes 7, 8 thereby lead tangentially into the swirl chamber 3 and are arranged mutually opposite so that a flow subjected to a swirling action will develop in the swirl chamber 3 when a liquid fuel/air mixture is made to flow into it through the admission holes 7, 8.

Provided in the head 6 is an outlet hole 9, with the longitudinal axis of the outlet hole 6 coinciding with that of the hollow cylinder 5.

Atomizing can be selectively set by the diameters and pitch chosen for the admission holes 7, 8 and by their diameter ratio with respect to the outlet hole 9.

The head 6 joins the hollow cylinder 5 with a rounded part 13 and the—as viewed from the swirl chamber 3—external circumferential edge of the outlet hole 9 is provided with a bevel 14. The nozzle body 2 is thereby provided on its head side with round contours.

Provided around the outer circumference of the hollow cylinder 5 is a ring step 11, with the region of the hollow cylinder 5 extending from the ring step 11 to the base 4 having a smaller outer diameter than the region of the hollow cylinder 5 extending from the ring step 11 to the head 6.

FIGS. 2 and 3 show a blank 12 of the swirl atomizing nozzle 1. The blank 12 differs from the nozzle body 2 of the swirl atomizing nozzle 1 in that the head 6 has not yet been formed. Rather it is the case that the blank 6 with the base 4 is shaped like a half-sealed hollow cylinder having an open longitudinal end 16 with an opening 15.

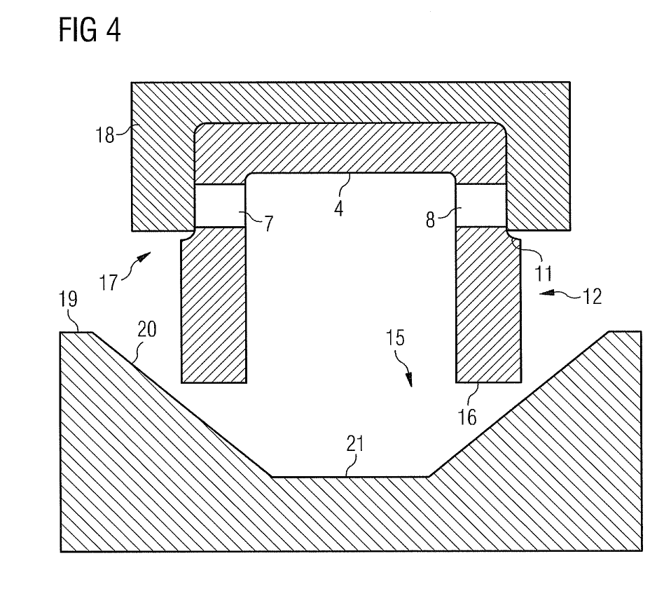

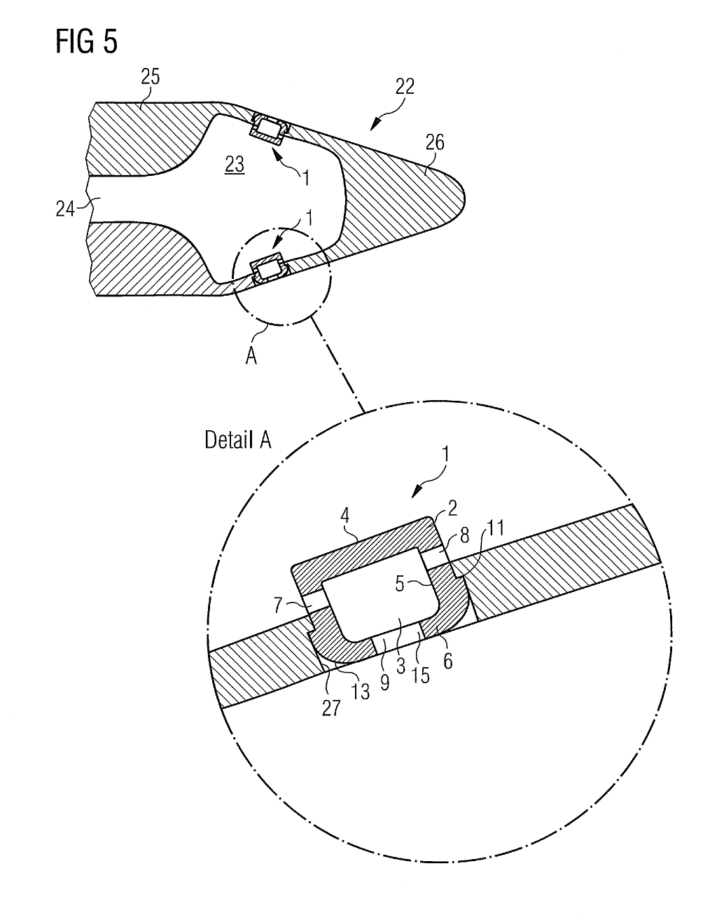

FIG. 4 shows a press 15 having a retaining sleeve 18 and a shaping stamp 19. The sleeve 18 has a recess reproducing the shape of the blank in the region extending from the ring step 11 to the base 4. The blank 12 is set into the recess, with the blank 12 being supported on the ring step 11 on the retaining sleeve 18 and the admission holes 7, 8 being covered by the retaining sleeve 18.

The open longitudinal end 16 of the blank 12 furthermore projects from the retaining sleeve 18 and is arranged facing the shaping stamp 19.

On its side facing the longitudinal end 16, the shaping stamp 19 has a cone 20 whose longitudinal axis coincides with the longitudinal axis of the retaining sleeve 18, with the cone 20 being bridged in its central region by a floor 21 that is perpendicular to the longitudinal axis of the cone 20.

The cone 20 and floor 21 are embodied such that the longitudinal end 16 will strike the cone 20 and slide inwardly toward the longitudinal axis of the retaining sleeve 18 when said sleeve is moved parallel to its longitudinal axis toward the shaping stamp 19. The open longitudinal end 16 finally reaches the floor 21 while being subjected to roll-forming, as a result of which the head 6 will be formed with its rounded part 13, with the outlet hole 9 remaining in the region of the longitudinal axis of the retaining sleeve 18.

FIG. 5 shows a nozzle assembly 22 inside which is embodied a nozzle assembly chamber 23. The liquid fuel flows through a nozzle assembly chamber inlet opening 24 into the nozzle assembly chamber 23.

The nozzle assembly 22 has a cylindrical section 25 and a conical section 26, with the nozzle assembly chamber 23 being embodied both in the cylindrical section 25 and in the conical section 26 and the conical section 26 forming a termination of the nozzle assembly chamber 23.

Arranged in the conical section 26 and distributed evenly around the circumference are nozzle assembly chamber outlet holes 27 in each of which is housed a swirl atomizing nozzle 1. The swirl atomizing nozzle 1 is housed in the nozzle assembly chamber outlet hole 27 in such a way that the head 6 is flush with the outer surface of the conical section 26 and the region of the nozzle body 2 projects into the nozzle assembly chamber 23 in which the admission holes 7, 8 and base 4 are provided.

The liquid in the nozzle assembly chamber 23 enters the swirl chamber 3 through the admission holes 7, 8 with a swirl flow developing, flows out again through the outlet hole 9 with predetermined atomizing of the liquid fuel, and is ducted to a downstream combustion chamber. The air is mixed with the exiting atomized liquid prior to combustion by being directed at it in a transverse stream. The swirl atomizing nozzles 1 are caulked and/or soldered into the nozzle assembly chamber outlet holes 27.

1.-10. (canceled)

11. A swirl atomizing nozzle for atomizing liquid fuel for a gas turbine, comprising:
a nozzle body including a hollow cylinder terminated by a base on one side and a head on the other side so that a swirl chamber is formed in the nozzle body;
an admission hole arranged in a plane perpendicular to a longitudinal axis of the hollow cylinder and positioned at an angle in a circumferential direction of the hollow cylinder, the admission hole being provided in the vicinity of the base in the hollow cylinder;
an outlet hole arranged in the head, the outlet hole lying on the longitudinal axis of the hollow cylinder so that a liquid can flow tangentially into the swirl chamber through the admission hole under an impact of a swirling action and flow axially out of the swirl chamber through the outlet opening;
a ring step arranged around the longitudinal axis of the hollow cylinder on an outer circumference of the hollow cylinder viewed in the longitudinal direction of the hollow cylinder between the admission hole and the head such that the outer diameter of the hollow cylinder is smaller at the admission hole than at the head,
wherein the ring step is already provided in the swirl atomizing nozzle blank so that the swirl atomizing nozzle blank can be inserted base first into a retaining sleeve,
such that the swirl atomizing nozzle will not be subjected to any undesired deformation due to undesired bending of the swirl atomizing nozzle blank between the ring step and base during the production of the swirl atomizing nozzle.

12. The swirl atomizing nozzle as claimed in claim 11, wherein a diameter-to-height ratio of the nozzle body is less than one.

13. The swirl atomizing nozzle as claimed in claim 11, wherein the swirl atomizing nozzle has two admission holes in the plane arranged point-symmetrically around a midpoint of the hollow cylinder with longitudinal axes that run parallel to each other.

14. The swirl atomizing nozzle as claimed in claim 13, wherein the admission holes are drilled holes and/or slots.

15. The swirl atomizing nozzle as claimed in claim 11, wherein the plane is sited closer to the base than to the head.

16. A nozzle assembly for a gas turbine burner, comprising:
a conical section including a nozzle assembly chamber; and
a nozzle assembly chamber outlet hole, a. swirl atomizing nozzle with a base projecting into the nozzle assembly chamber being provided in the conical section of the nozzle assembly, such that a liquid can flow from the nozzle assembly chamber into a swirl chamber through an admission hole under an impact of a swirling action and out of the swirl chamber through an outlet opening of the nozzle assembly chamber;
wherein a plurality of nozzle assembly chamber outlet holes and the swirl atomizing nozzles respectively located therein are arranged around a circumference of the conical section, and
wherein each swirl atomizing nozzle is caulked into position in the nozzle assembly chamber outlet hole.

17. A method for producing a swirl atomizing nozzle, comprising:
providing a blank with a hollow cylinder terminated on one side by a base and with an open longitudinal end on the other side,
wherein an admission hole is arranged in a plane perpendicular to a longitudinal axis of the hollow cylinder and positioned at an angle tangentially to a circumference of the hollow cylinder in the vicinity of the base in the hollow cylinder, and
wherein a ring step around the longitudinal axis of the hollow cylinder is optionally embodied on an outer circumference of the hollow cylinder viewed in a longitudinal direction of the hollow cylinder between the admission hole and the open longitudinal end so that, referred to the ring step, an outer diameter of the hollow cylinder is smaller on the side with the admission hole than on the side with the open longitudinal end;
providing a press with a retaining sleeve and a shaping stamp formed by a cone and a floor and aligns with the retaining sleeve;
inserting the blank into the retaining sleeve, base first, until the retaining sleeve makes contact,
wherein the blank is supported on the ring step on the retaining sleeve so that undesired bending of the blank between the ring step and the base cannot occur during production of the swirl atomizing nozzle, and
wherein the open longitudinal end of the blank faces the cone; and
pushing the retaining sleeve toward the shaping stamp so that the open longitudinal end will at the same time be reshaped inwardly by the cone and floor, and the open longitudinal end forming an outlet opening will come to rest perpendicularly to the longitudinal axis of the blank.

18. The method as claimed in claim 17, wherein the blank is a turned part.

19. The method as claimed in claim 17, wherein the shaping stamp is mounted freely rotating around an axis of symmetry of the cone so that the blank will be roll-formed.

20. The method as claimed in claim 17, further comprising:
boring the outlet opening to a predetermined diameter.

21. The method as claimed in claim 17, further comprising:
producing the admission hole as a tangentially positioned slot and/or drilled hole.
